(19) United States
(12) Patent Application Publication
(10) Pub. No.: US 2006/0236674 A1
(43) Pub. Date: Oct. 26, 2006

(54) Method for the production of chains for articles of jewellery

(75) Inventor: Silverio Cerato, Mussolente (VI) (IT)

Correspondence Address: BROWDY AND NEIMARK, P.L.L.C.;624 NINTH STREET, NW, SUITE 300, WASHINGTON, DC, 20001-5303, US

(73) Assignee: SILMAR SPA, Romano d'Ezzelino (VI) (IT)

(21) Appl. No.: 10/541,789

(22) PCT Filed: Sep. 9, 2003
(86) PCT No.: PCT/EP03/09973

§ 371 Date: Mar. 24, 2006

(30) Foreign Application Priority Data
Jan. 13, 2003 (IT) PD2003A000005

(51) Int. Cl. F16G 13/00

(52) U.S. Cl. 59/82

(57) ABSTRACT

A method is described for producing chains for articles of jewellery in the form of a rope, comprising the steps of preparing a plurality of open rings (1), gripping and moving the rings (1) so as to prepare a sequence of respective pairs of adjacent rings with respective openings (4) facing each other and also joining the adjacent rings of each pair are to obtain a closed annular shape, the rings (1) of adjoining pairs having first being inserted, so as to obtain a structure with linked rings. The method provides for the rings (1) to be formed by cutting or stamping from sheet metal and for the adjacent rings (1) of each pair to be joined to each other by the corresponding limbs (5, 6), located near the respective openings (4), placed back to back, one resting on the other alternately.

### TECHNICAL FIELD

The invention relates to a method for the production of chains for articles of jewellery in accordance with the preamble of the main claim number 1.

### BACKGROUND ART

The invention applies particularly though not exclusively to the specific sector of the production of chains in the form of a rope for goldsmiths and the jewellery sector in general.

The production of chains in the form of a rope or with double or triple links is known from the applicant's own manufacturing, using rings of solid or tubular metal wire. The method provides for the production of rings which are not completely closed in which the basic chain is obtained by placing two rings side by side with the respective openings opposite each other. A successively repeated sequence of steps carried out by manipulating the rings with suitable motorised tweezers leads to the formation of a chain with a typical rope form. When the chain is assembled, that is after the rings intended to form the chain links have been positioned in the manner indicated, the adjacent rings with the openings opposite each other are soldered together to give a stable connection of the entire chain structure.

### DISCLOSURE OF THE INVENTION

One purpose of the invention is to produce chains for articles of jewellery of the type indicated with remarkable characteristics of flexibility and lightness of the chain structure compared with known solutions styled so that they are also of pleasing design and striking appearance.

This purpose is achieved by the invention by means of a method for the production of chains for articles of jewellery comprising the steps defined in the appended claims. Chains for articles of jewellery produced according to the above-mentioned method are also the subject of the invention.

### BRIEF DESCRIPTION OF THE DRAWINGS

The characteristics and advantages of the invention will become clear from the following detailed description of a preferred example of embodiment illustrated purely by way of non-limiting example with reference to the appended drawings in which:

FIGS. 1 to 5 show in succession different steps in executing the method proposed by the invention for producing a length of chain.

### PREFERRED EMBODIMENT OF THE INVENTION

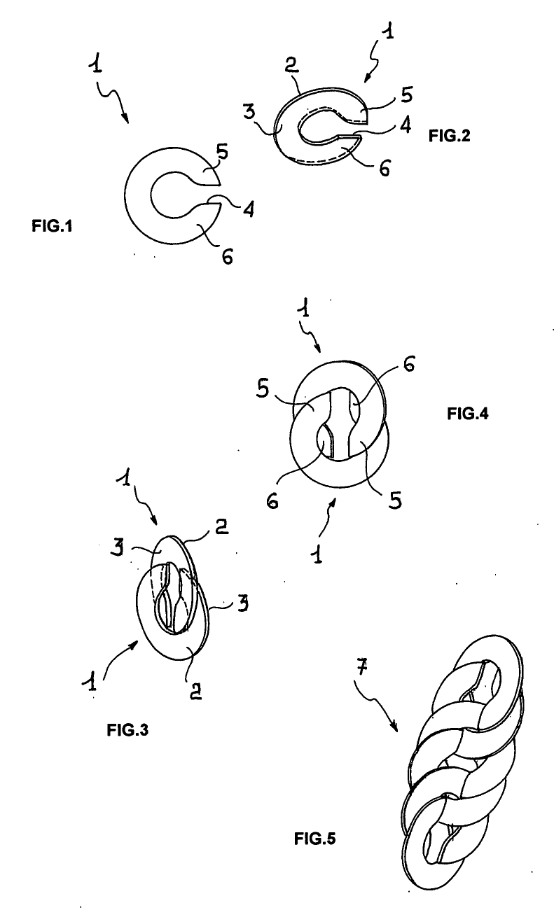

With reference firstly to FIGS. 1 and 2, the number 1 indicates a ring constituting the basic element for producing lengths of chain in accordance with the method proposed by the invention. These chains are of course prepared for the production of articles for goldsmiths and the jewellery sector in general, for example for the production of necklaces, bracelets and similar.

The method according to the invention provides for a plurality of rings 1 to be prepared by cutting or stamping from sheet metal of selected thickness S. The cutting produces the ring 1 with the shape of a flattened annulus not completely closed, defined between opposite surfaces 2, 3. The open ring 1 is thus obtained with an opening 4 forming a break in the circumference, defined between opposite portions of limbs 5, 6 of the ring. Provision is also made for the possibility of production by cutting or stamping of rings with shapes other than a truly annular form.

A subsequent step in the method provides for ordering and manipulating the rings by means of gripping tweezers provided in equipment which is conventional in itself, and also known from the applicant's own manufacturing, according to procedures such as to arrange a sequence of respective adjacent pairs of rings 1 with the respective openings 4 facing each other. The partial insertion of one ring into the other, via the openings 4, leads to the configuration in FIG. 3. Next, the rings 1 are rotated with respect to each other about diametral axes so as to be arranged with the corresponding limbs 5, 6 placed back to back. It will be noted that by means of the above-mentioned rotation, the respective limbs 5, 6 are placed back to back, one resting on the other alternately, as shown in FIG. 4.

A further step in the method provides for the adjacent rings of each pair to be joined to each other, the rings of adjoining pairs having first been inserted, so as to obtain a structure with linked rings. The joint is obtained by spot soldering at points of contact between the surfaces 2, 3 of the corresponding limbs 5, 6 placed back to back. By soldering the rings of each pair, a closed annular structure is obtained, constituting the basic unit for producing a length of chain, indicated as a whole by the number 7 and shown in the perspective view in FIG. 5.

In a variant embodiment of the method proposed by the invention, provision is also made for a subsequent step of ornamental marking of the rings 1 by means of surface engraving of the opposite surfaces 2, 3 of each ring. This operation is carried out on the chain for decorative purposes. Alternatively, provision is made for the surfaces 2, 3 to be decorated by stamping with selected decorative patterns.

The method described thus produces a chain structure with an overall appearance which resembles the configuration of chains in the form of a rope, and at the same time has characteristics of remarkable overall lightness, mainly due to the fact that rings of flattened, shape or of different profiles are used, cut from sheets of precious metal of extremely small thickness. The cutting of the ring from sheet metal also avoids the limits encountered in bending rings of wire due to the stretching and deformation of the materials.

The invention thus achieves the purposes proposed, offering the advantages indicated compared with known solutions.

In particular, there is the advantage of being able to produce chains of remarkable lightness and flexibility and yet of pleasing design and striking appearance.

1. A method for producing chains for articles of jewellery in the form of a rope, comprising the steps of:
preparing a plurality of open rings (1),
gripping and moving the rings (1) so as to prepare a sequence of respective pairs of adjacent rings (1) with respective openings (4) facing each other,
joining together the adjacent rings (1) of each pair to obtain a closed annular form, the rings (1) of adjoining pairs having first been inserted, so as to obtain a structure with linked rings,
characterised in that said rings (1) are formed by cutting or stamping from sheet metal and the adjacent rings (1) of each pair are joined to each other with the corresponding limbs (5, 6), located near the respective openings (4), placed back to back, one resting on the other alternately.

2. A method according to claim 1 in which said limbs (5, 6) are joined to each other by spot soldering.

3. A method according to claim 1 or 2, in which the rings (1) are cut or stamped from sheet metal with a thickness such as to give the ring the form of a flattened annulus not completely closed, defined between opposite annular surfaces (2, 3).

4. A method according to one of the preceding claims, comprising the further step of diamond point surface engraving of the opposite surfaces (2, 3) of each ring.

5. A method according to one of claims 1 to 3, comprising the step of surface stamping of decorative patterns on the opposite surfaces of each ring (1).

6. A chain for articles of jewellery comprising rings (1) linked together with each other produced according to the method in one or more of claims 1 to 5.
